(19) United States
(12) Patent Application Publication
(10) Pub. No.: US 2006/0169563 A1
(43) Pub. Date: Aug. 3, 2006

(54) Method and apparatus for controlling the cooling of a clutch and for switching a safety function of the clutch of a motor vehicle

(75) Inventor: Mario Schaufler, Kehl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/317,674

(22) Filed: Dec. 23, 2005

(30) Foreign Application Priority Data
Dec. 24, 2004 (DE) 10 2004 062 607.3

(51) Int. Cl. F16D 48/06

(52) U.S. Cl. 192/85 R; 192/113.3

(57) ABSTRACT

A method and apparatus for controlling the cooling of a clutch and for switching a safety function of the clutch of a motor vehicle through a pilot pressure controlled by an electrically operated pilot valve. A coolant valve and a safety valve are controlled as a function of an electric current that operates the pilot valve to provide a pilot pressure to the valves. At least one switching point of the safety valve that is associated with a predetermined value of the electric current is adjusted depending on the electrohydraulic system. The electric current is controlled by a control unit.

### BACKGROUND OF THE INVENTION

1. Field of the Invention

The present invention relates to a method and apparatus for controlling the cooling of a clutch, and for switching a safety function of the clutch of a motor vehicle by way of a pilot pressure controlled by an electromagnetically operated pilot valve, wherein a coolant valve and a safety valve are controlled as a function of an electric current to operate the pilot valve.

2. Description of the Related Art

Methods and apparatus of that sort, with which both the cooling of the clutch and the safety function for the clutch are controllable, are known from motor vehicle technology. An electromagnetic proportional valve, a coolant valve, and a safety valve are usually used to that end. The proportional valve provides a predetermined pilot pressure, which on first approximation is proportional to the electric current being applied to the electromagnetically operated proportional valve. The pilot pressure pressurizes a control surface of the control piston of the coolant valve, for example, so that a force is exerted on the control piston which counteracts the spring force and the backpressure acting on the return surface of the control piston.

That backpressure in the coolant valve, in turn, depends on the volume flow of coolant applied at the time to cool the clutch. The result is that by increasing the pilot pressure the volume flow of coolant to cool the clutch is also increased. If the volume flow of coolant coming from the cooler return is greater than necessary for the corresponding backpressure, the surplus volume flow of coolant can be fed directly to the pump circuit of a hydraulic pump.

Along with that function to control the volume flow of coolant, the safety valve is also controlled by the pilot pressure predetermined by the proportional valve. That is achieved by the fact that the force acting on the control piston of the safety valve due to the pilot pressure is greater than the pre-stressing of the spring, so that the piston begins to move. In the switched state, the clutch pressure set by the clutch valve is disconnected from the clutch and the clutch is vented to the tank. That triggers the safety function, in which the clutch is disengaged so that the vehicle can be stopped safely.

In order to be able to trigger that safety function with the safety valve, in the known apparatus or the known method the electric current for controlling the proportional valve is increased to about 1000 mA, to ensure that the safety function is realized by triggering the safety valve. In order to have an adequate safety margin between the triggering of the safety valve and the normal clutch cooling function, in the known system a maximum electric current of 595 mA is used for cooling the clutch. A fixed cooling volume flow that enables a certain cooling capacity is allocated to that electric current. It has become evident, however, that in certain driving situations that cooling volume flow is not sufficient to reliably protect the clutches from damage. Without expensive changes to the known system, it is not possible to increase the cooling volume flow without producing the risk of unintentionally triggering the safety function unintentionally.

Accordingly, the present invention has as an object the provision of an apparatus and a method of the type identified at the beginning, with which a greater cooling capacity is made possible without at the same time triggering an unwanted actuation of the safety function.

### SUMMARY OF THE INVENTION

That object is achieved in accordance with the present invention by a method for controlling the cooling of a clutch and for switching a safety function of the clutch of a vehicle through a pilot pressure controlled by an electrically operated pilot valve. A coolant valve and a safety valve are controlled as a function of an electric current to operate the pilot valve, and at least one switching point of the safety valve that is associated with a predetermined value of the electric current is adjusted depending on the electrohydraulic system. That means that without any change to the so-called hardware of the system the possibility exists of adjusting the electric current for setting the cooling volume flow to the system in such a way that a maximum cooling capacity is realized without the danger of the safety function being actuated unintentionally. In that adjustment, in accordance with the invention, even with unfavorable tolerance situations, even addition of a maximum clutch cooling current is made possible without triggering the safety function.

In order to ascertain the actual switching points of the safety valve for the particular electrohydraulic system and to determine a maximum possible cooling flow, it is possible in accordance with an advantageous embodiment of the present invention to provide that the electric current for controlling the electromagnetically operated pilot valve, which preferably can be a proportional valve, is controlled by a predetermined ramp function, or the like, to switch the safety valve, in which the particular associated value of the electric current to trigger and to end the safety function is ascertained.

In that way it is possible to ascertain a maximum possible cooling flow depending upon various parameters of the electrohydraulic system, with an appropriate safety margin to prevent an unwanted triggering of the safety function. Parameters that can be considered in the method in accordance with the invention include, for example, tolerances of the hydraulic control of the system, in particular the tolerance situation of the proportional valve, the temperature drift of the hydraulic control of the system, a tolerance of the electric control of the system, and also statistical measurement errors. Other characteristics of the electric current for control are also conceivable in order to ascertain the particular assigned values of the electric current for triggering and ending the safety function.

In a refinement of the present invention, provision can be made so that the particular current needed to trigger and to end the safety function is reduced by a predetermined safety factor. That safety factor, or that safety margin or value can be for example 15 mA, so that it becomes possible with the usual control to increase the cooling volume flow by the equivalent of 15 mA, or for the predominant part of the control by 90 mA, or even by a maximum of 130 mA. That increases the associated cooling flow correspondingly, so that critical situations due to thermal overheating of the clutch in operation are prevented. For example, that can prevent failures of the motor vehicle or of the clutch due to so-called clutch juddering. Overall, the operating reliability of the entire system and of the vehicle can be increased thereby. As a result, by updating the control behavior of the system, it is possible to achieve a reduction of the return portion.

A further design can provide for the clutch operating pressure to be monitored by a clutch pressure sensor, or the like, in order to detect switching of the safety valve. The existing clutch pressure sensor can be used in order to determine the electric current at which the clutch pressure sets in, and hence at which the safety function is triggered. At the same time, tolerances of both the hydraulic and the electric control system can also be measured and eliminated.

It is especially advantageous if the control of the safety valve in a motor vehicle with an automated transmission is performed with the transmission in a park position. In that position it is possible to perform a switching of the safety valve for adjustment without triggering critical driving situations. However, other operating conditions in which that adjustment is performable are also conceivable.

Another advantage of the method in accordance with the invention results from the fact that a characteristic curve, or a characteristic map, can be generated based on the temperature drift of the hydraulic control, for example. Other parameters are also employable. That enables demand-dependent cooling of the transmission as a function of the transmission temperature.

The object underlying the invention is also achieved by apparatus for controlling the cooling of a clutch and for switching a safety function of the clutch of a vehicle, having an electromagnetically operated pilot valve for controlling a pilot pressure. A coolant valve and a safety valve are pressurizable with the pilot pressure that is controlled as a function of an electric current to operate the pilot valve, and the electric current is controllable by a controller. In accordance with the invention, the controller can perform adjustment of at least one switching point of the safety valve that is associated with a predetermined value of the electric current, as a function of the electrohydraulic system. In particular, the arrangement or system can be used to carry out the proposed method, so that the advantages identified in conjunction with the description of the method, and other advantages and characteristics, also result from the system in accordance with the invention.

Preferably, it is possible with the system in accordance with the invention, for example through the controller or the like, to control the electric current by a predetermined ramp function to switch the safety valve, where the particular associated values of the electric current to trigger and to end the safety function are ascertainable.

The ascertained values can preferably be stored in the controller. It is also possible for those values to be received by other storage media, or the like, and then processed. Those values can also be reduced by a predetermined safety factor or safety value.

It is especially advantageous in the system in accordance with the invention, in accordance with a different design, for the adjustment of the particular switching point of the safety valve in a motor vehicle with an automated transmission to be provided with the transmission in a park position. Thus the adjustment can occur without detracting from the driving operation in any way.

Thus, overall, a system in accordance with the invention is proposed with which, without changes to the hardware, improved clutch cooling is attainable by adjusting the switching point of the safety valve appropriately, so that the electric current for controlling the coolant valve can be increased without triggering the safety valve unintentionally.

It would also be conceivable to use two separate proportional valves for the cooling and for the safety function. That is more cost intensive, however.

### BRIEF DESCRIPTION OF THE DRAWINGS

The structure, operation, and advantages of the present invention will become further apparent upon consideration of the following description, taken in conjunction with the accompanying drawings in which:

FIG. 1 is a schematic view of one embodiment of apparatus for controlling a pilot valve for cooling a clutch and for switching a safety function of the clutch of a motor vehicle; and

FIG. 2 is a graph showing the electric current, the backpressure, and the clutch pressure during cooling and the switching of the safety function, and also a graph showing the adjustment of the switching point of the safety function on the basis of the identified variables.

### DESCRIPTION OF THE PREFERRED EMBODIMENTS

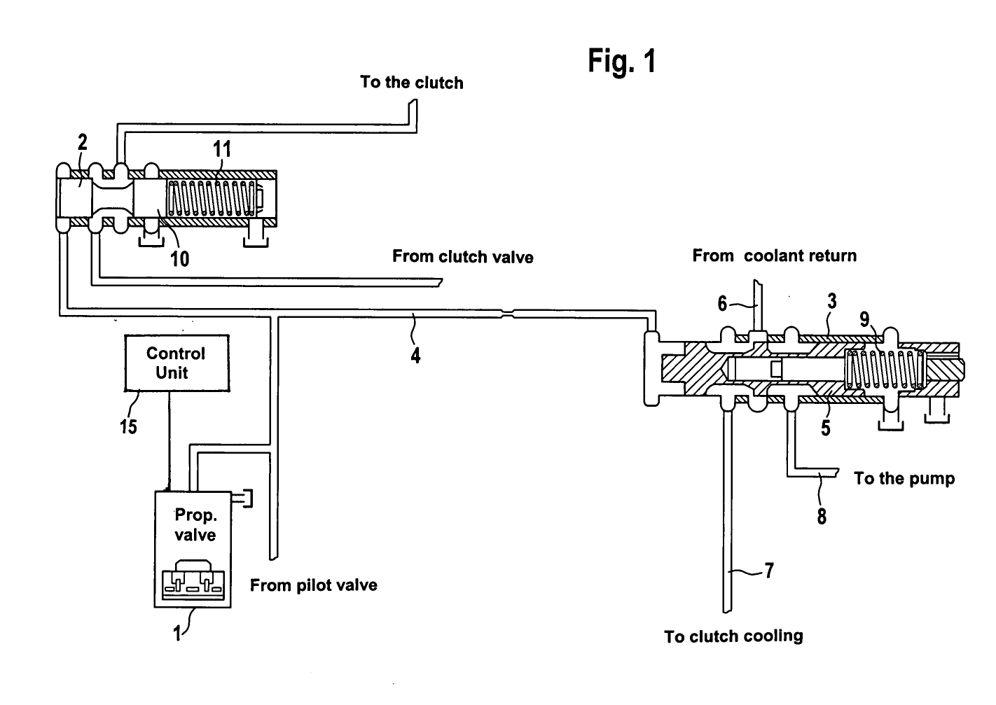

FIG. 1 shows an embodiment of apparatus in accordance with the invention for controlling the cooling of a clutch and for switching a safety function of the clutch of a motor vehicle. The apparatus includes an electromagnetically operated pilot valve 1 for controlling a pilot pressure, a coolant valve 3, and a safety valve 2 that is pressurized with the pilot pressure that is controlled as a function of an electric current to operate the pilot valve 1, wherein the electric current is controlled by a suitable control unit 15.

To control a volume flow of coolant, the coolant valve 3 is provided, which is coupled with the pilot valve 1 by a pilot conduit 4. Coolant valve 3 includes a control piston 5 which, depending upon activation, couples a coolant circuit return conduit 6, a coolant circuit supply conduit 7, and a hydraulic pump supply conduit 8 with each other. The control piston 5 of coolant valve 3 is biased by a spring element 9.

The pilot valve 1, in the form of a proportional valve, makes a predetermined pilot pressure available in the pilot conduit 4, which on first approximation is proportional to the electric current setting at pilot valve 1. Through the pilot pressure a force is exerted on a control surface of the control piston 5 of coolant valve 3, which acts against the spring force of spring element 9 and counter to the backpressure of the coolant circuit supply conduit 7 which is acting on the return surface of the control piston 5 of the coolant valve 3. That backpressure is, in turn, dependent on the coolant volume flow of the coolant circuit.

As a result, by increasing the pilot pressure in the pilot conduit 4, the coolant volume flow to the clutch cooling system is also increased through corresponding movement of the control piston 5 of the coolant valve 3. As soon as the coolant volume flow coming from the coolant circuit return conduit 6 is greater than is needed for the corresponding backpressure in the coolant circuit supply conduit 7, the surplus coolant volume flow is conducted directly to the pump supply conduit 8 of the hydraulic pump.

Furthermore, the pilot valve 1 and the pilot pressure provided in the pilot conduit 4 by the pilot valve 1 also controls the safety valve 2 to trigger or to end a safety function at the clutch. As soon as the force acting on the control piston 10 of safety valve 2 becomes greater than the force of the biasing by a spring element 11 against piston 10 of the safety valve, the control piston 10 begins to move. In the switched state, the clutch pressure is disconnected from the clutch by the clutch valve, which is not shown in further detail, and the clutch is connected to a tank for venting, so that the clutch is depressurized and is accordingly able to be opened if required by a particular driving situation.

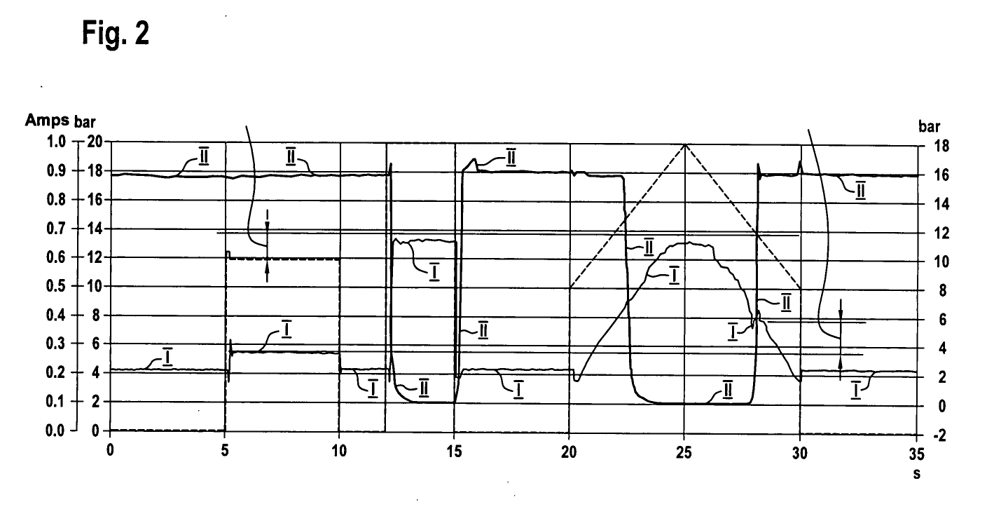

The functioning of the apparatus in accordance with the invention, and also that of the method in accordance with the invention, will be explained in greater detail on the basis of the graph shown in FIG. 2.

In the graph, the electric current for controlling the electromagnetically operated pilot valve 1 is represented by a dashed line over time. The course of the backpressure of the coolant valve 3 in the coolant circuit is designated by I in FIG. 2. The course of the clutch pressure over time is designated by II.

In the left part of FIG. 2, the sequence of a cooling phase of the clutch is indicated on the basis of the courses of the variables identified above. At time T=5 seconds, by controlling pilot valve 1 the backpressure I, and hence the coolant volume flow, is increased by increasing the electric current to control pilot valve 1, briefly to 610 mA and then to 595 mA. That results in the backpressure I, which is a function of the electric current. The cooling phase ends at time T=10, at which the electric current is reduced to 0 mA. That also reduces the coolant volume flow and the backpressure I.

At time T=12 seconds, which is shown near the middle part of the diagram, the safety function is switched. That is accomplished by switching the electric current at pilot valve 1 to 1000 mA, so that safety valve 2 is switched accordingly. As a result, the clutch pressure II drops toward 0 bar in a very short time. At time T=15 the safety function is ended again, by reducing the electric current to 0 mA. That causes the clutch pressure II to rise again to its original value.

In the right part of FIG. 2, a possible adjustment of the switching point of safety valve 2 is indicated at time T=20 seconds. Also at time T=20 the electric current is first increased to 0.5 mA, and then a current ramp function is triggered, so that the switching point of safety valve 2 is able to be adjusted. At the same time, the system monitors at what electric current present at pilot valve 1 the clutch pressure II drops, and at what electric current the clutch pressure II rises again. The triggering of the safety function is marked by the drop in the clutch pressure II, and the ending of the safety function of safety valve 2 is marked by the clutch pressure II rising again.

From the electric currents ascertained at those switching points, less a safety margin, it is possible then to determine the maximum possible coolant flow for the proportional valve or for the pilot valve 1 with that hydraulic system. Additional parameters, such as the transmission oil temperature, could also be integrated into that adjustment function.

In the diagram shown in FIG. 2, the possible increase in the backpressure I is indicated by a double arrow in the right part of the diagram, wherein the increase in the backpressure I corresponds to the increase in the coolant flow volume. The possible increase in the electric current for controlling pilot valve 1 is indicated in the left part of the diagram.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A method for controlling the cooling of a clutch and for switching a safety function of the clutch of a motor vehicle through an electrohydraulic system including a pilot pressure controlled by an electrically operated pilot valve, said method comprising the steps of: controlling a coolant valve and a safety valve as a function of an electric current that operates the pilot valve; and adjusting at least one switching point of the safety valve that is associated with a predetermined value of the electric current as a function of the electrohydraulic system.

2. A method in accordance with claim 1, including the step of controlling the electric current by a predetermined ramp function to switch the safety valve, wherein a particular associated value of the electric current to trigger and to end the safety function is ascertained.

3. A method in accordance with claim 2, wherein the particular current value necessary to trigger and to end the safety function is reduced by a predetermined safety factor.

4. A method in accordance with claim 1, including the step of monitoring a clutch operating pressure by a clutch pressure sensor to detect switching of the safety valve.

5. A method in accordance with claim 1, including the step of actuating the safety valve in a motor vehicle having an automated transmission while the transmission in a park position.

6. A method in accordance with claim 1, including the step of ascertaining during the switching point adjustment at least one characteristic curve that takes into account temperature drift of the hydraulic system.

7. A method in accordance with claim 6, including the step of generating a characteristic map from a plurality of characteristic curves.

8. A method in accordance with claim 1, wherein in the switching point adjustment at least a transmission oil temperature is taken into account as a parameter.

9. Apparatus for controlling the cooling of a clutch and for switching a safety function of the clutch of a motor vehicle, said apparatus comprising: an electromagnetically operated pilot valve for controlling a pilot pressure; a coolant valve and a safety valve in fluid communication with the pilot valve that are pressurized with the pilot pressure, which is controlled as a function of an electric current to operate the pilot valve; a control unit for controlling the electric current is controlled by a control unit, wherein the apparatus carries out the method in accordance with claim 1, and wherein an adjustment of at least one switching point of the safety valve associated with a predetermined value of the electric current is performed by the control unit as a function of the hydraulic system.

10. Apparatus in accordance with claim 9, wherein the control unit controls the electric current by a predetermined ramp function to switch the safety valve, and wherein the control unit ascertains the particular associated value of the electric current to trigger and to end the safety function.

11. Apparatus in accordance with claim 10, wherein each value ascertained is stored by the control unit.

12. Apparatus in accordance with claim 11, wherein a particular electric current necessary to trigger and to end the safety function is reduced by a safety factor stored in the control unit.

13. Apparatus in accordance with claim 9, including a clutch pressure sensor for monitoring a clutch operating pressure in order to detect a switching of the safety valve.

14. Apparatus in accordance with claim 9, wherein at least one characteristic curve ascertained in an adjustment is stored in the control unit.

15. Apparatus in accordance with claim 9, wherein the adjustment of the particular switching point of the safety valve in a motor vehicle with an automated transmission is performed with the transmission in a park position.

16. Apparatus in accordance with claim 9, wherein a characteristic map generated from a plurality of characteristic curves is stored in the control unit.
